(19) United States
(12) Patent Application Publication
(10) Pub. No.: US 2019/0384554 A1
(43) Pub. Date: Dec. 19, 2019

(54) Systems and Methods of Processing Print Jobs at an Imaging Device

(71) Applicant: Lexmark International, Inc., Lexington, KY (US)

(72) Inventors: Sven Dellagnolo, Lexington, KY (US); Matthew Douglas Field, Lexington, KY (US); Chad Eugene McQuillen, Lexington, KY (US); Kenneth C. Napier, Georgetown, KY (US)

(21) Appl. No.: 16/236,553

(22) Filed: Dec. 30, 2018

Related U.S. Application Data
(60) Provisional application No. 62/684,510, filed on Jun. 13, 2018.

(51) Int. Cl. G06F 3/12

(52) U.S. Cl. CPC G06F 3/1267; G06F 3/1238; G06F 3/1292; G06F 3/1205

(57) ABSTRACT

A system including an imaging device and a mobile device communicatively connected to the imaging device for performing a method of processing print jobs at the imaging device, the method comprising receiving a print request to print from the mobile device and sending a unique identifier to the mobile device in response to the print request. The unique identifier is used in determining whether to print the job sent by the mobile device.

### CROSS REFERENCE TO RELATED APPLICATIONS

This patent application claims the benefit of the earlier filing date of U.S. Patent Application Ser. No. 62/684,510, entitled “System and Methods of Processing Print Jobs in an Imaging Device”, filed Jun. 13, 2018. This patent application is related to U.S. patent application Ser. Nos. ______ and ______, both filed contemporaneously herewith, both entitled “Systems and Methods of Processing Print Jobs at an Imaging Device”, which are both assigned to the assignee of the present application. The contents of all of the above applications are hereby incorporated by reference in their entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Technical Field

The present invention relates to a system and methods for releasing print jobs stored in imaging devices and, more particularly, to a system and methods for printing a document at an imaging device based upon successful payment of one or more pages of the document.

### 2. Description of the Related Art

Messaging applications in mobile devices often have payment methods embedded into their code space or ecosystem. These payment methods allow messaging application users or account holders to transfer money from their bank accounts to a bank account associated with another account holder in the messaging application (i.e., peer to peer). Account holders in messaging applications may include consumers and business owners wishing to connect to the consumers by pushing notifications to the mobile devices ranging from discount coupons, events, and other promotional or marketing materials. Business owners may employ the use of chatbots to manage their accounts in the messaging application. For example, chatbots may be configured to generate canned responses to any question received from an account holder, present the account holder with one or more web URL links upon user request and/or ask questions. Chatbots may also be configured to collect and/or store data based upon inputs of the account holder, such as payment for goods or services that were rendered.

A few payment methods for delivering goods or services to consumers using messaging applications in mobile devices are known in the art. One example system involves sending payment for processing a document using a messaging application in the mobile device, storing the document in a web-based service, generating a QR code associated with the document stored in the web-based service and using the QR code in retrieving the document from the web-based service and printing the document at a printing kiosk linked to the web-based service. Another example system involves sending payment to a web-based service for printing a photo document, directly sending the document via a messaging application from the mobile device to a printing kiosk located close to the mobile device and connected to the web-based service, and using the printing kiosk to customize the photo document prior printing. In both of these example paid printing methods, a connection of the printing kiosk to the Internet may be required in order to confirm payment of the document prior to its release for printing. Yet another example payment method involves the purchasing of vending machine products using a standalone application in the mobile device while the user of the mobile device is within Bluetooth-detectable range of the vending machine. Still, this example method requires the vending machine to include additional hardware so users can discover and establish a connection with the vending machine.

While the aforementioned solutions allow payment and release of a document from the user's mobile device, these solutions require at least one of an Internet connection or additional hardware and/or software configurations to the device. Accordingly, it is desirable to have a system and methods for releasing paid print job pages sent from a mobile device in an imaging device for printing with lesser or without additional configurations to the imaging device.

### SUMMARY

Example mobile printing systems including an imaging device and example methods for releasing stored print jobs for printing based upon payment are disclosed. A print job may be sent from a mobile device communicatively connected to the imaging device via a connector application in the mobile device. Payment for printing one or more pages in the imaging device may be made via a messaging application in the mobile device, the messaging application being communicatively connected to an Internet-based messaging and payments service. A software program such as a chatbot may be used to transfer payment information generated by the messaging and payments service to a receipt service associated with an owner of the imaging device for tracking receipts. The connector application may request a receipt from the receipt service and send the receipt to the imaging device for verification of the imaging device prior to performing a printing operation.

One example embodiment of a method of releasing print jobs at an imaging device includes receiving a print request to print from a mobile device communicatively connected to the imaging device and sending a unique identifier to the mobile device in response to the print request. The unique identifier is used in determining whether to print a document sent by the mobile device.

One example imaging device includes a non-transitory computer readable storage medium containing one or more instructions for processing print jobs. The one or more instructions include an instruction to receive a print request to print from a mobile device communicatively connected to the imaging device, send a unique identifier to the mobile device in response to the print request to print, receive a receipt from the mobile device; and determine whether the receipt includes the unique identifier, and process a print job from the mobile device upon a determination that the receipt includes the unique identifier.

Other example embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows an example system for releasing a stored print job, according to one example embodiment.

FIGS. 2A-2E show example screenshots of an example mobile device for sending a document to an example imaging device in the example system of FIG. 1.

FIGS. 3A-3E show example screenshots in an example mobile device of an example messaging application.

FIG. 4 is an example flowchart depicting an example method for generating an example receipt.

FIG. 5 is a sequence diagram including an example set of actions performed by the different components shown in FIG. 1.

FIG. 6 shows an example system for authorizing printing in an imaging device, according to another example embodiment.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included or substituted for those of others. The scope of the present disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including”, “comprising”, or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions.

These computer program instructions may be loaded onto a general purpose computer, special purpose computer, or other programmable data processing apparatus to produce a machine, such that the instructions which execute on the computer or other data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions, and program instruction means for performing the specified functions. It will also be understood that each block of the diagrams, and combinations of blocks in the diagrams, may be implemented by special purpose hardware-based computer systems that perform the specified functions or steps, or combinations of special purpose hardware and computer instructions.

Disclosed is a system including example methods for releasing stored print jobs in an imaging device. The print jobs may be sent from a mobile device communicatively connected to the imaging device via a connector application in the mobile device. Payment may be made via a messaging application in the mobile device connected to the Internet. Different methods for determining, in an imaging device which may have no connection to the Internet, whether payment for a print job has been made and for releasing the print job will be discussed in greater detail below.

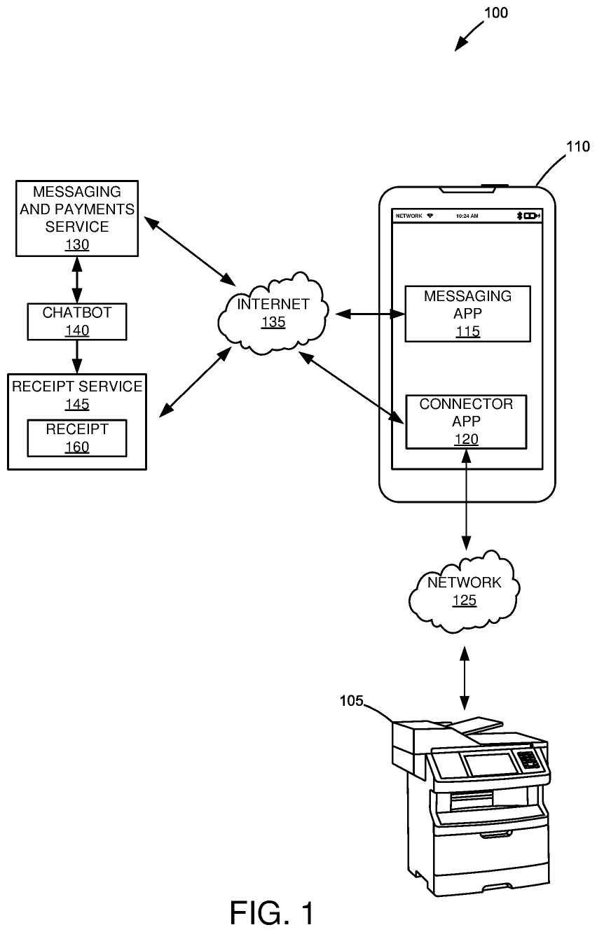

FIG. 1 shows an example system 100 for releasing a print job, according to one example embodiment. Example system 100 includes at least one imaging device 105 and at least one mobile device 110 communicatively connected to imaging device 105. Mobile device 110 may include a messaging application 115 and a connector application 120. Connector application 120 may be communicatively connected to imaging device 105 via a network 125. Messaging application 115 may be communicatively connected to a messaging and payments service 130 via Internet 135. Messaging and payments service 130 may be communicatively connected to a chatbot 140. Chatbot 140 may be communicatively connected to a receipt service 145. Receipt service 145 may be communicatively connected with connector application 120 via Internet 135. Receipt service 145 may include a receipt 160 which may be referred to by imaging device 105 as a proof of payment prior releasing a stored print job.

Imaging device 105 may be a single function printer or a multi-function device capable of printing, scanning, faxing, copying, e-mailing, and/or other functions. Imaging device 105 may be communicatively connected to mobile device 110 via a communications link established using connector application 120, such as network 125. Network 125 may allow mobile device 110 to communicate with and to send print jobs directly to imaging device 105. An identifier of imaging device 105 (e.g., IP address, hostname, URL) may be provided in connector application 120 for network 125 to be established. In one example embodiment, an identifier of imaging device 105 may be manually entered into connector application 120. In another example embodiment, an identifier of imaging device 105 may be searched in network 125 and automatically added to a list of printers that are connected with connector application 120. In other example embodiments, imaging device 105 may be communicatively connected to connector application 120 via the Internet (not shown). Imaging device 105 may be able to receive and print documents from other mobile devices in addition to or in lieu of mobile device 110. Imaging device 105 may include a queue of documents for printing. In one example embodiment, the queue may be stored in a memory (not shown) of imaging device 105.

Mobile device 110 may be any mobile computing device which may be, for example, a smartphone, a laptop, a tablet, a smartwatch, and the like. Mobile device 110 may be capable of generating and/or storing a document (not shown). Mobile device 110 may be utilized by a plurality of users. Each user of mobile device 110 may have a corresponding account or profile in messaging application 115. For purposes of the present disclosure, a user of mobile device 110 and a user or account holder of messaging application 115 may be used interchangeably herein. It will be appreciated by those skilled in the art that while one mobile device 110 is shown in FIG. 1, multiple mobile devices may be present in example system 100. A user of mobile device 110 may opt to connect mobile device 110 to imaging device 105 via connector application 120.

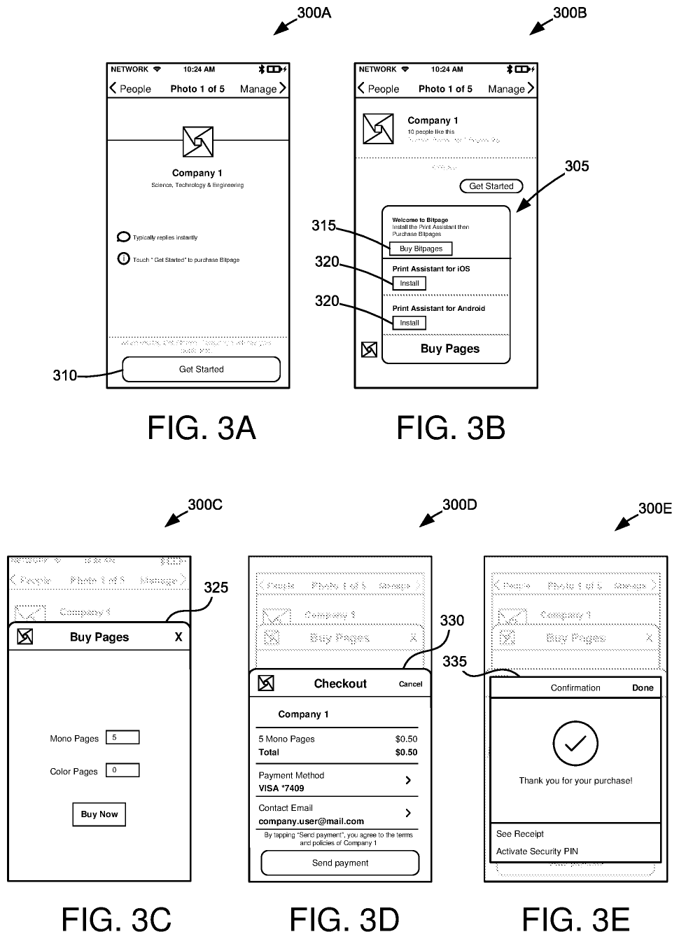

Messaging application 115 may be any messaging application capable of transmitting messages or communicating with messaging and payments service 130. In one example embodiment, messaging application 115 may be installed in mobile device 110. In other example embodiments, messaging application 115 may be an application accessible through a browser in mobile device 110. Messaging application 115 may include a set of user interface components (e.g., buttons, icons, tabs) for display on mobile device 110, as is shown in FIG. 3A-3E. Messaging application 115 may be connected to messaging and payments service 130 via Internet 135 to exchange and receive messages from messaging and payments service 130. In one example embodiment, messaging application 115 may be connected to Internet 135 via a cellular data network connection. In another example embodiment, messaging application 115 may be connected to Internet 135 via a Wi-Fi connection.

Messages sent by messaging application 115 may be in the form of a text message, a photo or a moving image, and the like of which is known in the field of messaging using Internet 135. A user or account holder in messaging application 115 may have an associated profile registered in messaging and payments service 130. An account holder may be a person, an organization, or a business entity. Bank account details of each user or account holder of messaging application 115 may be tied to his or her respective accounts in messaging and payments service 130. Bank account details may refer to credit card or debit card details of the user, according to one example embodiment. Using these details, each user may be able to pay for any goods or services sold by messaging and payments service 130 via messaging application 115.

Connector application 120 may be an application in mobile device 110 enabling mobile device 110 to send a document to imaging device 105. The document may be an electronic document stored on or accessible through mobile device 110. Connector application 120 may include an interface to show to a user of mobile device 110 information concerning use of imaging device 105, such as printing features and other functional capabilities of imaging device 105. Connector application 120 may include a function to disconnect with imaging device 105 and establish a connection with another imaging device which may be similar in configuration as imaging device 105. Connector application 120 may be aware of a number of pages of a selected document in mobile device 110. In one example embodiment, connector application 120 may indicate to a user of mobile device 110 a number of pages of a document selected for printing to imaging device 105.

In one example embodiment and as shown in FIG. 1, connector application 120 may not be communicatively connected with messaging application 115. Messaging application 115 may be used for payment while connector application 120 may be used for sending communications to imaging device 105. When messaging application 115 and connector application 120 are both installed in mobile device 110, a coordinated user experience may be provided in mobile device 110 to guide the user through a pay-for-print experience. In another example embodiment, messaging application 115 may not be executed in mobile device 110 as a separate application from connector application 120. In such an example embodiment, a payment plugin or module of messaging application 115 may be integrated into connector application 120. In this embodiment, messaging application 115 may still be connected with messaging and payments service 130 over Internet 135.

Messaging and payments service 130 may be a service available over Internet 135. Messaging and payments service 130 may include a payments module. Messaging and payments service 130 may be used for managing data received from messaging application 115. Received data may include user accounts and/or payment details (e.g., bank account information, payment amount, etc.) of each user of messaging application 115. In some example embodiments, multiple messaging applications similar to messaging application 115 and installed on other mobile devices may simultaneously use messaging and payments service 130 to exchange messages.

Chatbot 140 may be a software program associated with an account of an owner of imaging device 105 in messaging application 115. While chatbot 140 is illustrated in FIG. 1 as an element separate from mobile device 110, chatbot 140 may operate when messaging application 115 is executed in mobile device 110. As is typical for bots, chatbot 140 may be set to provide a predetermined response to any input made by a user in messaging application 115. For example, chatbot 140 may provide a link for installing connector application 120 in messaging application 115 as a response to an initial input made by the user. Chatbot 140 may be used to share notifications with a user of mobile device 110 relating to imaging device 105, such as a price per page, printing discounts and other promotions, and the like. Chatbot 140 may also receive from messaging and payments service 130 payment information. Payment information may include the number of pages purchased for printing in imaging device 105. Chatbot 140 may include instructions to forward data from messaging and payments service 130 to receipt service 145, as will be discussed in greater detail below.

Receipt service 145 may be a dedicated server for storing information from chatbot 140. Receipt service 145 may be managed by an owner of imaging device 105. Receipt service 145 may include instructions for creating receipt 160 using information provided by chatbot 140. Receipt 160 may be an electronic file including information for releasing a stored print job in imaging device 105. In other example embodiments, receipt 160 may be used to allow printing of documents from mobile device 110 at imaging device 105. Information may include at least a number of pages purchased by a user of mobile device 110 via messaging application 115. Information on receipt 160 may further include an identifier of the print job stored in imaging device 105. In one example embodiment, receipt 160 may be created on demand or upon request of connector application 120. In other example embodiments, receipt 160 may be created following receipt of information by receipt service 145 from chatbot 140.

In the present disclosure, the document sent to imaging device 105 for printing may be composed of text, images, or a combination of both. The document may be comprised of one or more pages. In one example embodiment, the document may be in a format acceptable for printing at imaging device 105. In some example embodiments, connector application 120 in mobile device 110 may include instructions to convert the document to a format acceptable for printing in imaging device 105 prior to or in the course of sending the document to imaging device 105.

A number of pages for purchasing and/or their respective classifications (e.g., monochrome or colored page, single page or duplex page printing) may be referred to herein as the “payload”. The payload may consist of the number of pages for printing in imaging device 105. The payload may further consist of a classification of the pages based on print type, for example, whether printed as a monochrome or colored page or in one side or both sides of the media sheet. In the present disclosure, the number of pages purchased may be associated with the document to be printed. In printing the document, a user of mobile device 110 may send the payment for a predetermined number of pages to messaging and payments service 130 via messaging application 115. Messaging and payments service 130 may process the payment and generate the payload. Chatbot 140 may then forward the payload to receipt service 145 for receipt service 145 to use in creating receipt 160.

In one example embodiment, connector application 120 may send the document to imaging device 105, and imaging device 105 may place printing of the document on hold until receipt 160 is received from connector application 120. In another example embodiment, connector application 120 may request receipt 160 from receipt service 145 and send the document to imaging device 105 together or along with receipt 160. The document may be printed in imaging device 105 following verification of receipt 160.

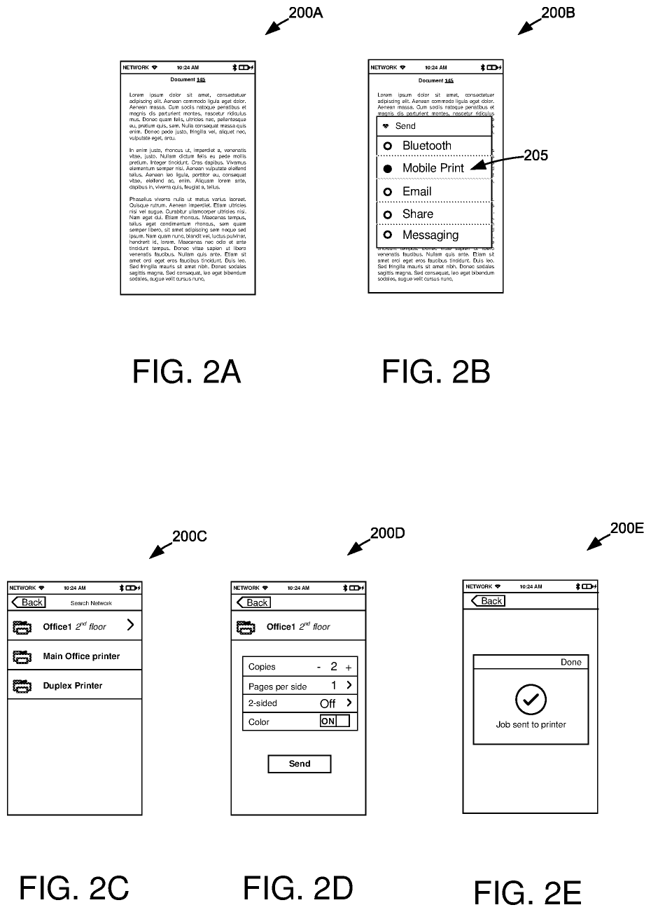

FIGS. 2A-2E show example screenshots in mobile device 110 for sending a document to imaging device 105. FIG. 2A shows an example screenshot 200A of an example document displayed on mobile device 110. FIG. 2B shows an example screenshot 200B including an example pop-up interface for selecting an application to be used in processing the document in FIG. 2A, such as connector application 120. FIG. 2C shows an example screenshot 200C of an example page for selecting a particular imaging device 105 to be used in processing the example document of FIG. 2A following the selection in FIG. 2B. FIG. 2D shows an example screenshot 200D of print preferences that the user may select prior printing the document using imaging device 105 selected in FIG. 2C. FIG. 2E shows an example screenshot 200E indicating a successful sending of the document from mobile device 110 to imaging device 105 selected in FIG. 2C.

FIGS. 3A-3E show example screenshots in mobile device 110 of messaging application 115. FIG. 3A shows an example screenshot 300A of an example welcome message associated with an account of an owner of imaging device 105 in messaging application 115. FIG. 3B shows an example screenshot 300B of an example conversation 305 between the user of mobile device 110 and chatbot 140. Example conversation 305 may be initiated as a result of an input made by the user of mobile device 110 in FIG. 3A, such as clicking Get Started link 310. FIG. 3C shows an example screenshot 300C showing an example pop-up display 325 overlaying example conversation 305 shown in FIG. 3B. In FIG. 3C, pop-up display 325 may be generated by chatbot 140 for receiving a number of pages of the document for printing in imaging device 105. FIG. 3D shows an example screenshot 300D of another example pop-up display 330 in messaging application 115 confirming the input of the user's payment details in FIG. 3C. FIG. 3E shows an example screenshot 300E of yet another example pop-up display 335 in messaging application 115 indicating the successful transmission of the payment details (shown in FIG. 3D) to messaging and payments service 130.

While example screenshots for connector application 120 (FIGS. 2A-2E) are presented before the example screenshots for messaging application 115 (FIGS. 3A-3D), it is to be understood that the user may execute messaging application 115 first and enter payment for printing per page of the document prior to launching connector application 120 and sending the document to the selected imaging device 105.

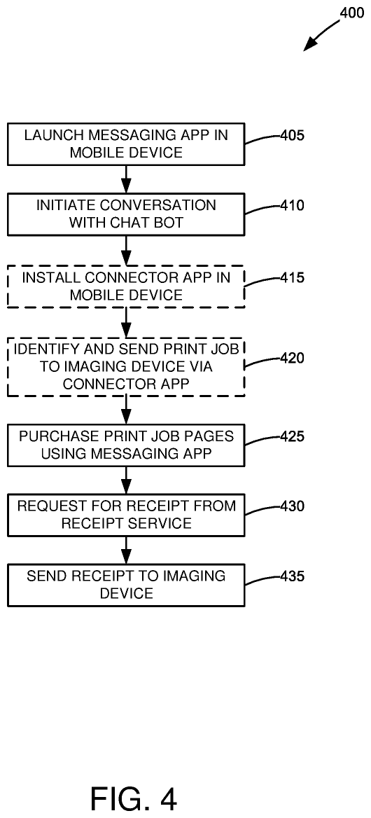

FIG. 4 is an example flowchart 400 depicting an example method for generating an example receipt 160. Receipt 160 may be used to release a document at imaging device 105 for printing.

At block 405, messaging application 115 may be launched in mobile device 110 by, for example, clicking an icon corresponding to messaging application 115 on a display interface of mobile device 110 or another method known in the art. At block 410, messaging application 115 may initiate an automated conversation with an owner of imaging device 105 via chatbot 140. In one example embodiment, a user of mobile device 110 may search for an account of the owner of imaging device 105 in messaging application 115. In this embodiment, the user of messaging application 115 may be directed by messaging and payments service 130 to chatbot 140 following the identification of an account of the owner of imaging device 105 in messaging and payments service 130. FIG. 3A shows an example account in messaging application 115 of the owner of imaging device 105 (e.g., “Company 1”). FIG. 3B shows example conversation 305 between a user of mobile device 110 and chatbot 140.

At optional block 415, chatbot 140 may send instructions to a user of mobile device 110 on how to install connector application 120 on mobile device 110. The user of mobile device 110 may identify whether or not connector application 120 is installed on mobile device 110. Once connector application 120 is installed on mobile device 110, chatbot 140 may send information to the user of mobile device 110 on how to use connector application 120 for sending a document to imaging device 105 for processing or printing.

At optional block 420, the user may identify a document or print job stored in mobile device 110 for sending to imaging device 105. In one example embodiment, a document may be opened in mobile device 110 (see FIG. 2A). Following identification, mobile device 110 may send the selected document to imaging device 105 via link 205 associated with connector application 120 (see FIG. 2B). In another example embodiment, the user may execute connector application 120 prior to selecting the document for printing.

At block 425, the user of mobile device 110 may purchase a number of pages for printing in imaging device 105 using messaging application 115. The one or more pages may correspond to a number of pages of the document sent at block 420. In some example aspects, the number of pages may correspond to the number of pages a user desires to print. Payment for the number of pages may be processed by messaging and payments service 130 connected to messaging application 115 via Internet 135. Chatbot 140 may receive the number of purchased pages as well as their respective classifications (payload) from messaging and payments service 130. Chatbot 140 may then forward the payload to receipt service 145.

At block 430, connector application 120 may send a request for receipt 160 from receipt service 145. Connector application 120 may send a nonce or unique identifier to receipt service 145 together with the request. The unique identifier may be associated with the document sent and placed on hold for printing in imaging device 105 (see block 420). The unique identifier may be generated by imaging device 105 upon receipt of the document from mobile device 110. As discussed above, receipt 160 may include the number of pages purchased and/or their respective print classifications. In one example embodiment, receipt 160 may include an encryption of the payload (digital signature). In another example embodiment, receipt 160 may include the unique identifier of the document in imaging device 105. In some example embodiments, receipt 160 may include an identifier of connector application 120.

At block 435, connector application 120 may send receipt 160 to imaging device 105. Upon receipt, imaging device 105 may determine whether receipt 160 received from mobile device 110 is valid. In one example embodiment, determining whether receipt 160 is valid may include determining whether receipt 160 includes a unique identifier associated with a document stored in imaging device 105. In some example aspects, determining whether receipt 160 is valid may include using the public key stored in imaging device 105 to verify the digital signature of receipt 160.

Following a determination that receipt 160 is valid, imaging device 105 may print the document sent by mobile device 110 (from optional block 420). In one example embodiment, imaging device 105 may release the held document and print the document upon a determination that receipt 160 is valid. In another example embodiment where block 420 is omitted, imaging device 105 may receive a document for printing together with receipt 160 from mobile device 110 and then print the document upon a determination by imaging device 105 that receipt 160 is valid such that the actions in block 420 and 435 may be performed together.

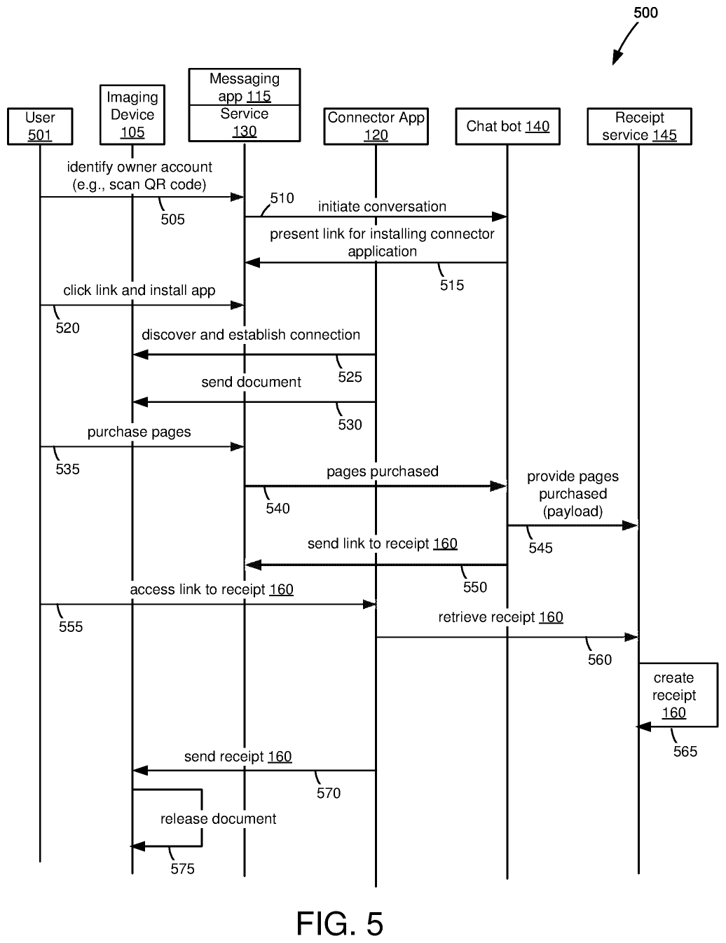

FIG. 5 is a sequence diagram 500 including example actions performed by the different components shown in FIG. 1. Sequence diagram 500 includes a user 501 of mobile device 110, imaging device 105, messaging application 115 and messaging and payments service 130, connector application 120, chatbot 140 and receipt service 145 as actors in performing an example application of the example method described in flowchart 400 of FIG. 4. For purposes of clarity and since messaging application 115 directly communicates with messaging and payments service 130 over Internet 135, actions performed by messaging application 115 and by messaging and payments service 130 are shown under a single column.

At step 505, user 501 may identify an account in messaging application 115 associated with an owner of imaging device 105. In one example embodiment, identifying the account may include scanning a QR code linked to an account of the owner of imaging device 105 in messaging application 115. Other methods for identifying the account in messaging application 115 associated with an owner of imaging device 105 to allow use of imaging device 105 may be apparent in the art.

At step 510, following identification of the owner's account, user 501 (also an account holder in messaging application 115) may initiate a conversation with chatbot 140 via messaging application 115. User 501 may send a predetermined message to chatbot 140 for chatbot 140 to respond with information regarding usage of imaging device 105. For example and as shown in FIG. 3A, user 501 may click Get Started link 310 to start a conversation with chatbot 140. As a result, in FIG. 3B, chatbot 140 may be configured to provide to user 501 a link 315 for purchasing pages. Another link 320 for installing connector application 120 in mobile device 110 may also be provided to user 501 (see FIG. 3B). Other information such as how to connect with imaging device 105, how to send a job to imaging device 105, and the like, may be configured to be provided by chatbot 140 in messaging application 115.

At step 515, chatbot 140 may present user 501 in messaging application 115 with link 320 (FIG. 3B) for installing connector application 120. At step 520, user 501 may then click link 320 for installing connector application 120 on mobile device 110. While not shown, link 320 may lead the user to an application store (e.g., Google Play™ Store, Apple's App Store®, etc.) for downloading connector application 120 onto mobile device 110. Where connector application 120 is already installed on mobile device 110, user 501 may determine whether a version of connector application 120 installed on mobile device 110 needs updating. User 501 may proceed with updating connector application 120 when desired by user 501 or as necessary.

At step 525, connector application 120 may allow mobile device 110 to discover and establish a connection with imaging device 105. In one example embodiment, launching connector application 120 may allow mobile device 110 to send communications directly to imaging device 105. With reference to FIG. 1, while connector application 120 is shown to be connected to one imaging device 105, a plurality of other imaging devices may be located near mobile device 110 and may be discoverable by connector application 120. Thus, an owner of imaging device 105 may be an owner of a plurality of other imaging devices or a fleet of imaging devices. An account holder in messaging application 115 who is also an owner of a plurality of imaging devices may be configured to accept payments for printing on each of the plurality of imaging devices.

At step 530, connector application 120 may be utilized by user 501 to send a document from mobile device 110 to imaging device 105. In one example embodiment, user 501 may execute connector application 120 on mobile device 110, choose the desired document via connector application 120, and send the document to imaging device 105 via connector application 120. In some alternate example embodiments, user 501 may open the document in mobile device 110 and send the opened document to imaging device 105 via connector application 120 (see FIGS. 2A-2B). Following the sending of the document to imaging device 105, user 501 may be redirected from connector application 120 to messaging application 115 for purchasing one or more pages of document 145 in some example embodiments.

At step 535, user 501 may purchase one or more pages for printing in imaging device 105 using messaging application 115. In one example embodiment, user 501 may indicate a total number of pages of the document sent at step 530 in messaging application 115. In another example embodiment, user 501 may indicate in messaging application 115 a lesser number of pages relative to the total number of pages of the document so not all pages of the document may be printed.

At step 540, messaging application 115 may inform chatbot 140 of the number of pages for purchasing by user 501 as well as their respective classifications (payload) for printing in imaging device 105. Messaging application 115 may send to chatbot 140 the number of pages indicated by the user at step 535 via messaging and payments service 130.

At step 545, chatbot 140 may send the payload to receipt service 145. At step 550, chatbot 140 may then send a link to messaging application 115. The link may be executed in connector application 120 to access receipt service 145 and retrieve receipt 160. At step 555, user 501 may access the link received in messaging application 115 via connector application 120. In other example embodiments and where a module of messaging application 115 is embedded as part of connector application 120, user 501 may be required to log in to connector application 120 using his or her account in messaging application 115 upon receipt of the link prior to allowing connector application 120 to access receipt service 145.

At step 560, as a result of accessing the link provided by messaging application 115, connector application 120 may be able to retrieve receipt 160 from receipt service 145. With reference back to step 530, upon receiving the document from connector application 120, imaging device 105 may generate a unique identifier corresponding to the received document and may provide the unique identifier to connector application 120. Connector application 120 may send this unique identifier to receipt service 145, together with the request for receipt service 145 for use in creating receipt 160.

At step 565, receipt service 145 may create receipt 160 using at least the payload provided by chatbot 140 and/or the unique identifier from connector application 120. Receipt 160 may also include a digital signature. The digital signature may be generated by receipt service 145 when a request to create receipt 160 is received from connector application 120. In one example embodiment, the digital signature may be a hashed value of the payload (number of pages) encrypted with a private key maintained in receipt service 145.

At step 570, following successful receipt of receipt 160 from receipt service 145, connector application 120 may send receipt 160 to imaging device 105. Receipt 160 may be used by imaging device 105 to determine whether one or more pages has been paid for printing by user 501 of mobile device 110. In one example embodiment, imaging device 105 may have a public key stored thereon for decrypting the digital signature. Imaging device 105 may determine whether the digital signature indicated on receipt 160 matches a hashed value of the payload (derived using the public key) and may determine receipt 160 to be valid if so. Imaging device 105 may also determine whether the unique identifier within receipt 160 matches with the unique identifier associated with the document received from mobile device 110 (step 530) and determine that receipt 160 is valid upon a positive determination.

At step 575, upon a determination that the information within receipt 160 matches with the information expected by imaging device 105 (i.e., correct digital signature, unique identifier present), imaging device 105 may determine that receipt 160 is valid. Where a document is placed on hold for printing in imaging device 105 (step 535) or where a document is received together with receipt 160 in imaging device 105, imaging device 105 may proceed with printing one or more pages of the document following a determination that receipt 160 is valid.

Receipt 160 may be modified to control the production of copies of a particular document. In one example embodiment, receipt 160 may be modified based upon a number of pages of a document that are printed by imaging device 105, as tracked by connector application 120. For example, user 501 may initially send a 5-page document to imaging device 105 (via connector application 120) and then send payment for 3 pages of the same document to messaging and payments service 130 (via messaging application 115). A first receipt 160 indicating successful payment for printing 3 pages may be created in receipt service 145. Connector application 120 in mobile device 110 may request for receipt 160 from receipt service 145 and send receipt 160 to imaging device 105. Imaging device 105 may then print the first 3 pages of the document. Following printing of all 3 pages of the document, connector application 120 may inform user 501 that the last 2 pages of document 145 were not printed by imaging device 105. Connector application 120 may prompt user 501 to send payment for 2 pages of the same document to messaging and payments service 130. Receipt service 145 may create a second receipt 160 which may include the same identifier of the same document but may include a different number of pages based upon the new payment made. In some example embodiments, connector application 120 may send instructions to receipt service 145 to delete receipt 160 following use thereof in printing a document.

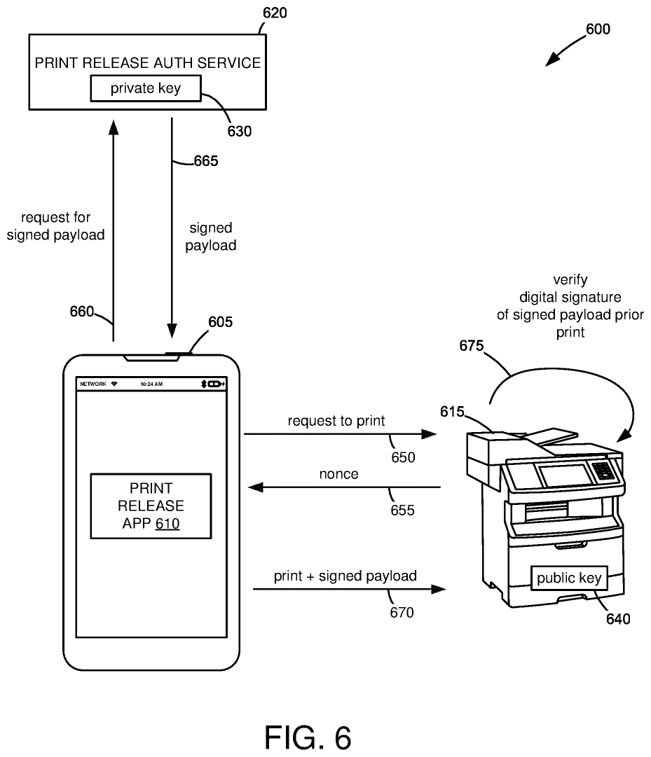

FIG. 6 shows an example system 600 for authorizing printing at an example imaging device, according to another example embodiment. Example system 600 includes an example mobile device 605 having an example print release application 610, an example imaging device 615 and an example print release authorization service 620. Print release authorization service 620 may include a private key 630. Imaging device 615 may include a public key 640. While not shown, mobile device 605 may be communicatively connected to print release authorization service 620 over the Internet. Mobile device 605 and imaging device 615 may be communicatively connected to each other via a predetermined network (not shown), such as the Internet.

Mobile device 605 may comprise the same elements as example mobile device 110 shown in FIG. 1. Print release application 610 may perform the same operations or be the same as connector application 120 described in FIG. 1, which allows mobile device 605 to send a document or a print job to a predetermined imaging device. Print release authorization service 620 may perform the same operations or be the same as receipt service 145 described in FIG. 1, which includes an instruction to create a receipt. In other example embodiments, print release authorization service 620 may be a server dedicated to accepting payments for printing one or more pages at imaging device 615 to.

FIG. 6 further shows actions 650-675 performed by the aforementioned components to allow printing by imaging device 615. Actions 650-675 may show another example embodiment of controlling usage of imaging device 615 based upon authorized payments.

At step 650, mobile device 605 may send a request to print to imaging device 615. Mobile device 605 may send the request via print release application 610. The request may include a document for printing by imaging device 615. The document may be stored in a memory of mobile device 605 (not shown). In other example embodiments, the document may be accessed from a remote location via print release application 610 and sent to imaging device 615 for printing.

In one example embodiment, the request may be triggered via a user interface in print release application 610. For example, a user may be instructed to click a button displayed when print release application 610 is executed in mobile device 605. The instruction may be to send the printing request to imaging device 615. The printing request may also be referred to as a request for access.

At step 655, imaging device 615 may send a nonce to mobile device 605. In one example embodiment, the nonce may be an identifier of the document sent by mobile device 605 along with the printing request (step 650). In another example embodiment, the nonce may be an identifier of mobile device 605. In other example embodiments, the nonce may be a unique identifier generated by imaging device 615 based upon the received printing request at step 650.

At step 660, mobile device 605 may send a request for a signed payload from print release authentication service 620. The request may be sent by print release application 610. As discussed above, the payload may refer to a number of pages purchased by the user as well as their respective print classifications. Upon receiving the request, print release authentication service 620 may encrypt the payload using private key 630 to generate a signed payload. In one example embodiment, the request for the signed payload may include the nonce received at step 655. In other example embodiments, the request for the signed payload may include an identifier of imaging device 615 and/or mobile device 605.

At step 665, print release authentication service 620 may send the signed payload to mobile device 605 following receipt of the printing request. Communications between mobile device 605 and print release authentication service 620 may be made through the Internet (not shown). At step 670, mobile device 605 may then send the signed payload to imaging device 615. Mobile device 605 may send the signed payload along with an instruction to print a document. In one example embodiment, and where a document is sent to imaging device 615 together with the printing request (see step 650), mobile device 605 may send the signed payload together with an instruction for imaging device 615 to start printing the document.

At step 675, imaging device 615 may verify a digital signature of the signed payload. As discussed above, the digital signature may refer to the encryption of the payload information using private key 630 in print release authentication service 620. Verifying the digital signature may include processing the signed payload using public key 640 in imaging device 615.Verifying the digital signature may also include determining whether the payload processed using public key 640 is the same as the signed payload received at step 670. Upon a determination that the signed payload and the processed payload are the same, imaging device 615 may determine that the digital signature is correct. Imaging device 615 may then print the document sent from mobile device 605.

It will be appreciated that the actions described and shown in the example flowcharts may be carried out or performed in any suitable order. It will also be appreciated that not all of the actions described in FIGS. 4-6 need to be performed in accordance with the example embodiments and/or additional actions may be performed in accordance with other example embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of processing a document at an imaging device, comprising:
receiving a print request from a mobile device communicatively connected to the imaging device; and
sending a unique identifier to the mobile device in response to the print request,
wherein the unique identifier is used in determining whether to print a document sent by the mobile device.

2. The method of claim 1, wherein the receiving the print request includes receiving the document for printing from the mobile device.

3. The method of claim 1, further comprising receiving the document and storing the document in a memory of the imaging device.

4. The method of claim 1, wherein the unique identifier is generated based upon the document stored in a memory of the imaging device.

5. The method of claim 1, wherein the mobile device includes an application having an instruction to directly communicate with the imaging device.

6. The method of claim 5, wherein the application is communicatively connected to a receipt service for creating a payload associated with the document.

7. The method of claim 6, wherein the receipt service signs the payload with a private key to create a digital signature.

8. The method of claim 7, further comprising:
receiving the payload and the digital signature from the application;
verifying the digital signature using a public key; and
printing a number of pages of the document following a positive verification that the payload was signed with the private key, the number of pages being specified in the payload.

9. An imaging device having a non-transitory computer readable storage medium containing one or more instructions for processing print jobs, the one or more instructions comprising an instruction to:
receive a print request from a mobile device communicatively connected to the imaging device;
send a unique identifier to the mobile device in response to the print request;
receive a receipt from the mobile device;
determine whether the receipt includes the unique identifier; and
process a print job from the mobile device upon a determination that the receipt includes the unique identifier.

10. The imaging device of claim 9, further comprising an instruction to ignore the receipt from the mobile device upon a determination that the receipt does not include the unique identifier.

11. The imaging device of claim 9, wherein the determining the unique identifier follows the receipt of the print request.

12. The imaging device of claim 9, wherein the print request is received from a predetermined application in the mobile device communicatively connected to the imaging device.

13. The imaging device of claim 12, wherein the predetermined application is communicatively connected to a receipt service for creating a payload associated with a document for printing and wherein the receipt service signs the payload with a private key to create a digital signature.

14. The imaging device of claim 13, further comprising an instruction to:
receive the payload and the digital signature from the application;
verify the digital signature using a public key stored in the imaging device; and
print a number of pages of the print job following a positive verification that the payload was signed with the private key, the number of pages being specified in the payload.

15. A system, comprising:
an imaging device; and
a mobile device communicatively connected to the imaging device, wherein the imaging device includes an instruction to:
receive a request for access from the mobile device; and
send a unique identifier to the mobile device in response to the request,
wherein the unique identifier is used in determining whether to process a job from the mobile device.

16. The system of claim 15, wherein the mobile device is communicatively connected to the imaging device via a predetermined application in the mobile device configured to directly communicate with the imaging device.

17. The system of claim 16, wherein the predetermined application is communicatively connected to a receipt service for creating a payload associated with the job and wherein the receipt service signs the payload with a private key to create a digital signature.

18. The system of claim 17, wherein the imaging device further comprises an instruction to:
receive the payload and the digital signature from the predetermined application,
verify the digital signature using a public key stored in the imaging device, and
print a number of pages of the job following a positive verification that the payload was signed with the private key, the number of pages being specified in the payload.

19. The system of claim 15, wherein the imaging device further comprises an instruction to:
determine whether the unique identifier is received from the mobile device, and
process the job following a positive determination.

20. The system of claim 15, wherein the imaging device further comprises an instruction to:
determine whether the unique identifier is received from the mobile device, and
refrain from processing the job from the mobile device following one of a determination that no unique identifier is received from the mobile device and a determination that the unique identifier is not the unique identifier from the imaging device.
